(19) United States
(12) Patent Application Publication
(10) Pub. No.: US 2026/0039009 A1
(43) Pub. Date: Feb. 5, 2026

(54) ELECTRONIC DEVICE

(71) Applicant: Huawei Technologies Co., Ltd., Shenzhen (CN)

(72) Inventors: Baokun Xi, Shenzhen (CN); Jiaming Wang, Shanghai (CN); Fangchao Zhao, Shanghai (CN)

(21) Appl. No.: 19/356,518

(22) Filed: Oct. 13, 2025

Related U.S. Application Data
(63) Continuation of application No. PCT/CN2024/086527, filed on Apr. 8, 2024.

(30) Foreign Application Priority Data
Apr. 14, 2023 (CN) 202310417083.3

(51) Int. Cl. H01Q 1/24; H01Q 5/335

(52) U.S. Cl. CPC H01Q 1/242; H01Q 5/335

(57) ABSTRACT

An electronic device includes a radiator of a first antenna and a radiator of a second antenna, the radiator of the first antenna includes a first branch and a second branch, and the second branch is disposed between the first branch and the radiator of the second antenna. A gap is between the first branch and the second branch, and a gap is between the second branch and the radiator of the second antenna. Also included is a first matching module, a first capacitor, and a feeding portion. A first end of the first matching module is connected to the second branch, a second end of the first matching module is connected to the feeding portion, a first end of the first capacitor is connected to the first branch, and a second end of the first capacitor is connected between the first matching module and the feeding portion.

### CROSS-REFERENCE TO RELATED APPLICATIONS

This application is a continuation of International Application No. PCT/CN2024/086527, filed on Apr. 8, 2024, which claims priority to Chinese Patent Application No. 202310417083.3, filed on Apr. 14, 2023. The disclosures of the aforementioned applications are hereby incorporated by reference in their entireties.

### TECHNICAL FIELD

This application relates to the field of communication technologies, and in particular, to an electronic device.

### BACKGROUND

In the conventional technology, a plurality of antennas are disposed in an electronic device to implement different communication functions. However, due to a limited size of the electronic device, a distance between the antennas is short, resulting in mutual interference and poor isolation between the antennas. Poor isolation between two antennas not only reduces transmission efficiency of the two antennas, but also may damage a component like a filter. For example, an electronic device includes a first antenna and a second antenna, and the energized second antenna can excite an induced current on the first antenna. The induced current on the first antenna causes electromagnetic interference to a current on the second antenna. Consequently, transmission efficiency of the second antenna is reduced.

### SUMMARY

An objective of this application is to provide an electronic device. In this application, the electronic device implements high isolation between an antenna and another antenna located on a periphery of the antenna and high transmission efficiency of a plurality of antennas.

The electronic device provided in this application includes a radiator of a first antenna and a radiator of a second antenna that are disposed on a frame of the electronic device, where the radiator of the first antenna includes a first branch and a second branch, and the second branch is disposed between the first branch and the radiator of the second antenna; a gap exists between the first branch and the second branch, and a gap exists between the second branch and the radiator of the second antenna; the electronic device further includes a first matching module, a first capacitor, and a feeding portion; and a first end of the first matching module is connected to the second branch, a second end of the first matching module is connected to the feeding portion, a first end of the first capacitor is connected to the first branch, and a second end of the first capacitor is connected between the first matching module and the feeding portion.

In this application, in a multi-antenna application environment, the second antenna located on a periphery of the first antenna excites induced currents on the radiator of the first antenna, and the induced currents on the radiator of the first antenna cause electromagnetic interference to a current on the radiator of the second antenna. Consequently, isolation between the first antenna and the second antenna is poor. A first induced current generated by the energized second antenna on the first branch is smaller than a second induced current generated by the energized second antenna on the second branch. In this application, the first end of the first matching module is connected to the second branch, the second end of the first matching module is connected to the feeding portion, the first end of the first capacitor is connected to the first branch, and the second end of the first capacitor is connected between the first matching module and the feeding portion, so that the feeding portion can excite, on the second branch, an excitation current with a direction opposite to a direction of the second induced current. The excitation current can be used to cancel the second induced current excited by the second antenna on the second branch, reduce the current on the second branch, reduce electromagnetic interference of the first antenna to the second antenna, improve isolation between the first antenna and the second antenna, and improve transmission efficiency of the first antenna and the second antenna.

In addition, the first matching module is connected between the feeding portion and the second branch, and is configured to adjust impedance matching for the first antenna. The first capacitor can adjust impedance matching for the first antenna, so as to adjust a magnitude of the excitation current. The excitation current can be used to cancel, as much as possible, the second induced current excited by the second antenna on the second branch, so that almost no current exists on the second branch. This further reduces interference of the second induced current on the second branch to the second antenna, improves isolation between the first antenna and the second antenna, and further improves transmission efficiency of the first antenna and the second antenna.

In some implementations, the first branch has a first end portion and a second end portion that are disposed opposite to each other, and the second end portion is located between the first end portion and the second branch; and the first end portion is grounded, and the first capacitor is connected to the second end portion; or a connection point between the first capacitor and the first branch is located between the first end portion and the second end portion, and the first end portion or the second end portion is grounded; or the first capacitor is connected to the first end portion, and the second end portion is grounded.

In this implementation, the first feeding portion feeds the second end portion of the first branch by using the first capacitor, and feeds a third end portion of the second branch by using the first matching module. In the foregoing feeding manner, the first feeding portion can excite slot differential-mode currents on the first branch and the second branch. To be specific, the first feeding portion excites a first current on the first branch, and the first feeding portion excites a second current on the second branch. The first current and the second current have opposite current directions and a same magnitude.

When the first end portion is grounded, and the first capacitor is connected to the second end portion; or when the first capacitor is connected to the first end portion, and the second end portion is grounded, the first branch forms a left-hand antenna, where a dimension of the left-hand antenna is small. This facilitates miniaturization of the antenna.

When the connection point between the first capacitor and the first branch is located between the first end portion and the second end portion, and the first end portion or the second end portion is grounded, the first branch forms an IFA antenna.

In some implementations, the second branch has a third end portion and a fourth end portion that are disposed opposite to each other, and the third end portion is located between the first branch and the fourth end portion; and the first matching module is connected to the third end portion, and the fourth end portion is grounded; or a connection point between the first matching module and the second branch is located between the third end portion and the fourth end portion, and the third end portion or the fourth end portion is grounded; or the third end portion is grounded, and the first matching module is connected to the fourth end portion.

In this implementation, when the first matching module is connected to the third end portion, and the fourth end portion is grounded; or when the third end portion is grounded, and the first matching module is connected to the fourth end portion, the second branch forms a left-hand antenna, where a dimension of the left-hand antenna is small. This facilitates miniaturization of the antenna.

When the connection point between the first matching module and the second branch is located between the third end portion and the fourth end portion, and the third end portion or the fourth end portion is grounded, the second branch forms an IFA antenna.

In some implementations, the first matching module includes a second capacitor and/or an inductor.

In this implementation, the first matching module is configured to implement impedance matching for the first antenna.

In some implementations, a capacitance of the first capacitor is less than or equal to 1.5 picofarads.

In this implementation, an adjusted value can be used to optimize isolation between the first antenna and the second antenna, and ensure antenna performance of the first antenna and the second antenna. The capacitance of the first capacitor is set within this range, so that a magnitude of the excitation current (the second current) on the second branch is close to a magnitude of the second induced current on the second branch, thereby achieving technical effect of canceling, as much as possible, the second induced current excited by the second antenna on the second branch.

In some implementations, the electronic device further includes a second matching module, one end of the second matching module is connected to the second end of the first matching module, and the other end of the second matching module is grounded.

In this implementation, the second matching module can be configured to perform impedance matching, to improve radiation performance of the second branch.

In some implementations, the second matching module is a capacitor.

In this implementation, a resonant frequency of the second branch can be changed by adjusting a capacitance of the capacitor of the second matching module.

In some implementations, the capacitance of the first capacitor is greater than or equal to 0.2 picofarads and less than or equal to 0.6 picofarads; or
the capacitance of the first capacitor is greater than or equal to 0.5 picofarads and less than or equal to 1.5 picofarads.

In this implementation, an adjusted value can be used to optimize isolation between the first antenna and the second antenna, and ensure antenna performance of the first antenna and the second antenna.

In some implementations, both the first branch and the second branch operate at least in a first frequency band, and the first frequency band is greater than or equal to 1.7 GHZ and less than or equal to 2.7 GHZ.

In this implementation, the first frequency band can be an MHB frequency band of an LTE system, and a frequency range covered by the MHB frequency band can be from 1.71 GHz to 2.69 GHz.

In some implementations, the second matching module is an inductor.

In this implementation, the second matching module is disposed as the inductor, and the inductor and the second branch are connected in parallel, so that a second operating frequency band can be excited on the first antenna. This widens an operating frequency band range of the antenna, and facilitates miniaturization and integration of the antenna.

In some implementations, the capacitance of the first capacitor is greater than or equal to 0.4 picofarads and less than or equal to 1 picofarad.

In this implementation, an adjusted value can be used to optimize isolation between the first antenna and the second antenna, and ensure antenna performance of the first antenna and the second antenna.

In some implementations, the first branch, the second branch, and the second antenna all operate at least in a first frequency band, the second branch is also capable of operating in a second frequency band, and any frequency in the second frequency band is higher than any frequency in the first frequency band.

In this implementation, the antenna has a wide operating frequency band range. This facilitates miniaturization and integration of the antenna.

In some implementations, the first frequency band is greater than or equal to 1.7 GHZ and less than or equal to 2.7 GHZ, and the second frequency band is greater than or equal to 3.3 GHz and less than or equal to 3.8 GHz.

In this implementation, both the first antenna and the second antenna resonate in a B3 frequency band. The B3 frequency band is a band3 frequency band of an LTE system, and a frequency range covered by the B3 frequency band may be from 1710 MHz to 1880 MHz. The first antenna may further resonate in an N78 frequency band. A frequency range covered by the N78 frequency band may be from 3.3 GHz to 3.8 GHz.

In some implementations, the second antenna operates in the first frequency band.

In this implementation, when the second branch and the radiator of the second antenna operate in a same frequency band, that is, the second branch operates in the first frequency band, and the radiator of the second antenna operates in the first frequency band, isolation between the two radiators is poor. In embodiments of this application, a method for disposing the first branch and connecting the first capacitor between the first branch and the second branch can effectively improve isolation between the second branch and the second antenna, and improve radiation performance of the second antenna.

In some implementations, a dimension of the first branch in an extension direction of the first branch is equal to ⅛ of an operating wavelength and/or a dimension of the second branch in an extension direction of the second branch is equal to ⅛ of an operating wavelength, and the operating wavelength is a wavelength corresponding to a center frequency of the first frequency band.

In this implementation, feeding manners and grounding manners of the first branch and the second branch are designed, so that the first branch and the second branch form left-hand antennas. A dimension of the radiator (the first branch and the second branch) of the left-hand antenna may be ⅛ of the operating wavelength, and the dimension is small. This facilitates miniaturization of the antenna.

In some implementations, the electronic device further includes a third matching module, one end of the third matching module is connected to the first end of the first capacitor, and the other end of the third matching module is grounded.

In this implementation, a resonant frequency of the first branch can be changed by adjusting a capacitance of a capacitor of the third matching module.

In some implementations, the first branch, the second branch, and the radiator of the second antenna are disposed along an encircling direction of the frame, and the second branch is located between the first branch and the radiator of the second antenna.

In this implementation, if a distance between the second branch and the second antenna is shorter than a distance between the first branch and the second antenna, the first induced current generated by the energized second antenna on the first branch is smaller than the second induced current generated by the energized second antenna on the second branch.

In some implementations, the electronic device includes a hinge assembly and a first housing and a second housing that are connected to two sides of the hinge assembly, and the first housing and the second housing are capable of being unfolded or folded relative to each other; and the first branch and the second branch are disposed on a first frame of the first housing, and the radiator of the second antenna is disposed on a second frame of the second housing.

In this implementation, the electronic device is a foldable mobile phone. The first antenna and the second antenna are respectively disposed in the first housing and the second housing. When the electronic device is in an unfolded state, because the mobile phone has a small size, a distance between the first antenna and the second antenna that are respectively disposed in the first housing and the second housing is short. When the electronic device is in a folded state, because the first housing and the second housing are in a two-layer stacked state, a distance between the first antenna and the second antenna that are respectively disposed in the first housing and the second housing is also short.

In implementations of this application, when the distance between the first antenna and the second antenna is short, there may still be better isolation between the first antenna and the second antenna, so that the first antenna and the second antenna have better radiation performance, a service life of a component like a filter is long, and the electronic device has better communication performance.

### BRIEF DESCRIPTION OF THE DRAWINGS

FIG. 1 is a diagram of a structure of an electronic device in some embodiments according to this application;

FIG. 2 is a diagram of a structure of a frame shown in FIG. 1 in some embodiments;

FIG. 3 is a diagram of a partial structure of the frame shown in FIG. 2 in some embodiments;

FIG. 4 is a diagram of a structure of an electronic device in some other embodiments according to this application;

FIG. 5 is a diagram of a structure of the electronic device shown in FIG. 4 in a folded state;

FIG. 6 is a diagram of an exploded structure of the electronic device shown in FIG. 4 in some embodiments;

FIG. 7 is a diagram of a structure of a frame shown in FIG. 4 in some embodiments;

FIG. 8 is a diagram of a partial structure of the frame shown in FIG. 7 in some embodiments;

FIG. 9 is a diagram of a structure of a first antenna and a second antenna shown in FIG. 3 and FIG. 8 in some embodiments;

FIG. 10 is a diagram of current distribution of the first antenna and the second antenna shown in FIG. 9;

FIG. 11 is a diagram of an S-parameter curve and an isolation curve for a part of frequency bands, obtained by performing simulation on the first antenna and the second antenna shown in FIG. 9 in some embodiments;

FIG. 12 is a diagram of efficiency curves for a part of frequency bands, obtained by performing simulation on the first antenna and the second antenna shown in FIG. 9 in some embodiments;

FIG. 13 is a diagram of an S-parameter curve and an isolation curve for a part of frequency bands, obtained by performing simulation on the first antenna and the second antenna shown in FIG. 9 in some other embodiments;

FIG. 14 is a diagram of efficiency curves for a part of frequency bands, obtained by performing simulation on the first antenna and the second antenna shown in FIG. 9 in some other embodiments;

FIG. 15 is a diagram of an S-parameter curve and an isolation curve for a part of frequency bands, obtained by performing simulation on the first antenna and the second antenna shown in FIG. 9 in some other embodiments;

FIG. 16 is a diagram of efficiency curves for a part of frequency bands, obtained by performing simulation on the first antenna and the second antenna shown in FIG. 9 in some other embodiments;

FIG. 17 is a diagram of a structure of the first antenna shown in FIG. 9 in some other embodiments;

FIG. 18 is a diagram of current distribution of the first antenna shown in FIG. 17;

FIG. 19 is a diagram of a structure of the first antenna shown in FIG. 9 in some other embodiments;

FIG. 20 is a diagram of a structure of the first antenna shown in FIG. 9 in some other embodiments; and

FIG. 21 is a diagram of a structure of the first antenna shown in FIG. 9 in some other embodiments.

### DETAILED DESCRIPTION OF ILLUSTRATIVE EMBODIMENTS

The following describes embodiments of this application with reference to the accompanying drawings in embodiments of this application. In this specification, embodiments described with reference to the accompanying drawings are examples, and are intended to explain the present invention, but cannot be understood as a limitation on the present invention.

In the descriptions of embodiments of this application, it should be noted that terms “installation” and “connection” should be understood in a broad sense unless there is a clear stipulation and limitation. For example, “connection” may be a detachable connection, a non-detachable connection, a direct connection, or an indirect connection through an intermediate medium. In addition, “fastening” in this specification should also be understood in a broad sense. For example, “fastening” may be direct fastening or indirect fastening through an intermediate medium. “Fastening” means that two parts are connected to each other and remain a relative position relationship unchanged after the two parts are connected to each other. “Rotatable connection” means that two parts are connected to each other and can rotate relative to each other after the two parts are connected to each other. “Slidable connection” means that two parts are connected to each other and can slide relative to each other after the two parts are connected to each other. Orientation terms mentioned in embodiments of this application, for example, “top end”, “bottom end”, “side edge”, “inside”, “outside”, are merely directions in the accompanying drawings. Therefore, the orientation terms are used to better and more clearly describe and understand embodiments of this application, instead of indicating or implying that a specified apparatus or element needs to have a specific orientation, and be constructed and operated in the specific orientation. Therefore, this cannot be understood as a limitation on embodiments of this application. “A plurality of” refers to two or more than two.

In embodiments of this application, the terms “first”, “second”, “third”, and “fourth” are merely intended for a purpose of description, and shall not be understood as an indication or implication of relative importance or an implicit indication of a quantity of indicated technical features. Therefore, a feature defined by “first”, “second”, “third”, or “fourth” may explicitly or implicitly include one or more of the features.

In embodiments of this application, the term “a plurality of” means two or more. In addition, the term “and/or” describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

Reference to “an embodiment”, “some embodiments”, or the like described in this specification means that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “have”, and their variants all mean “include but are not limited to”, unless otherwise specifically emphasized in another manner.

It may be understood that the specific embodiments described herein are merely used to explain a related invention, but not a limitation on the invention. In addition, it should be noted that, for ease of description, only a part related to the invention is shown in the accompanying drawings.

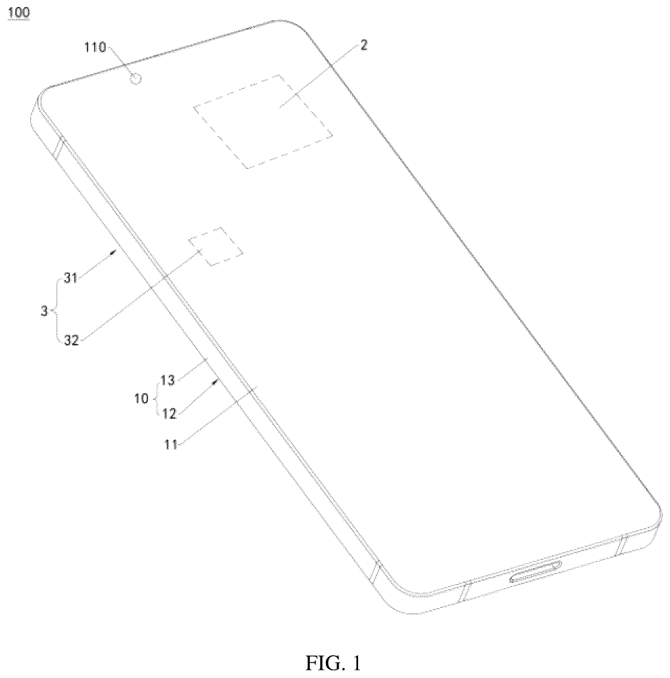

Refer to FIG. 1. FIG. 1 is a diagram of a structure of an electronic device 100 in some embodiments according to this application.

For example, the electronic device 100 may be an electronic product like a mobile phone, a tablet, a notebook computer, a wearable device, a point of sales terminal (POS), or an in-vehicle computer. Embodiments of this application are described by using an example in which the electronic device 100 is a mobile phone. In some embodiments, the mobile phone may be a bar phone shown in FIG. 1.

For example, the electronic device 100 may include a housing apparatus 10, a mainboard 2, and an antenna module 3. Space for accommodating electronic components is disposed inside the housing apparatus 10.

For example, the antenna module 3 may include an antenna assembly 31 and a communication module 32. The antenna assembly 31 is configured to transmit and/or receive an electromagnetic wave to implement a radiation function. The communication module 32 may integrate one or more components of at least one communication processing module. The communication module 32 may be configured to perform processing such as frequency modulation, amplification, and filtering on a signal.

For example, there may be a plurality of antenna modules 3. The plurality of antenna modules 3 may operate independently of each other, or may operate in combination. Each antenna module 3 in the electronic device 100 may be configured to cover one or more communication frequency bands. Different antenna modules 3 can also be reused, to improve utilization of the antenna modules 3. In some other embodiments, there may alternatively be one antenna module 3. This is not limited in embodiments of this application.

For example, the antenna assembly 31 in the antenna module 3 may include one or more radiators. The antenna assembly 31 can implement a MIMO system through a plurality of radiators, so that a capacity and spectrum utilization of a communication system can be multiplied without increasing a bandwidth.

In some embodiments, the plurality of radiators of the antenna assembly 31 in the antenna module 3 may be arranged in a 1×n (n>1) linear array manner, to effectively avoid mutual interference between another electronic component of the electronic device 100 and the antenna module 3. In some other embodiments, the antenna assembly 31 may alternatively be arranged in an m×n (m>1, and n>1) planar array manner, and may be specifically adjusted based on an overall design and arrangement of the electronic components of the electronic device 100.

The mainboard 2 is electrically connected to the antenna module 3, and is configured to supply power to the antenna module 3. The mainboard 2 may be configured to: carry the electronic components of the electronic device 100 and perform signal transmission. For example, the mainboard 2 may include a substrate, an application processor (AP) chip, and a plurality of baseband (BB) chips. The application processor chip and the plurality of baseband chips are all connected to the substrate, the application processor chip is electrically connected to one or more of the plurality of baseband chips, and some baseband chips of the plurality of baseband chips are electrically connected to each other.

In some embodiments, the substrate may include one or more circuit boards. The circuit board may be a printed circuit board (PCB) or a flexible circuit board (FPC). For example, the substrate may include the printed circuit board and/or the flexible circuit board. For example, the substrate may be a single-layer board or a multi-layer board. A type and a structure of the substrate are not specifically limited in this application. The substrate may include a metal layer, and the electronic component may also be electrically connected to the metal layer to implement grounding. In embodiments of this application, a metal layer of the circuit board may also be used as a ground plate of the electronic component. For example, as shown in FIG. 1, the communication module 32 and the mainboard 2 may be disposed separately. In some other embodiments, the communication module 32 may alternatively be integrated into the mainboard 2.

The electronic device 100 may further include a processor (not shown in the figure). The electronic device 100 may communicate with a network and another device by using a wireless communication technology via the antenna module 3, the processor, and the like, to implement a wireless communication function. In some embodiments, at least some functional modules of the communication module 32 may be disposed in the processor. In some other embodiments, at least some functional modules of the communication module 32 and at least some modules of the processor may be disposed in a same component.

The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), Bluetooth (BT), a global positioning system, a global navigation satellite system, a wireless local area network (WLAN) (for example, a Wi-Fi network), a short-range wireless communication technology (NFC), frequency modulation (FM), an infrared (IR) technology, and/or the like.

In some embodiments, the electronic device 100 may include a screen 11, and the screen 11 is mounted on the housing apparatus 10. The housing apparatus 10 may include a rear cover 12 and a frame 13. The screen 11 and the rear cover 12 are oppositely disposed at two sides of the frame 13. The screen 11, the rear cover 12, and the frame 13 jointly enclose internal space of the housing apparatus 10. The screen 11 may integrate a display function and a touch sensing function. The display function of the screen 11 is displaying an image, a video, and the like, and the touch sensing function of the screen 11 is sensing a touch action of a user, to implement man-machine interaction. The rear cover 12 may include a metal piece, and the electronic component may be electrically connected to the metal piece of the rear cover 12 to implement grounding. In some embodiments, an antenna may be electrically connected to the metal piece of the rear cover 12 to implement grounding.

For example, the rear cover 12 and the frame 13 may be fastened in a manner of adhesive bonding, welding, snap-fit connections, screw connection, or the like, and the rear cover 12 and the frame 13 may alternatively be integrated into an integral structure by using an integral molding process. Integrating two components into an integral structure by using an integral molding process means that, in a process of forming one of the two components, the component is connected to the other component, and the two components are connected without secondary processing (for example, adhesive bonding, welding, snap-fit connections, or screw connection).

For example, the mainboard 2 and the antenna module 3 may be integrated in internal space of the housing apparatus 10. In some other embodiments, a partial structure (for example, the radiator) of the antenna module 3 may further reuse all or a part of the metal piece of the rear cover 12 or all or a part of a metal piece of the frame 13, and perform radiation by using the metal piece of the rear cover 12 or the frame 13.

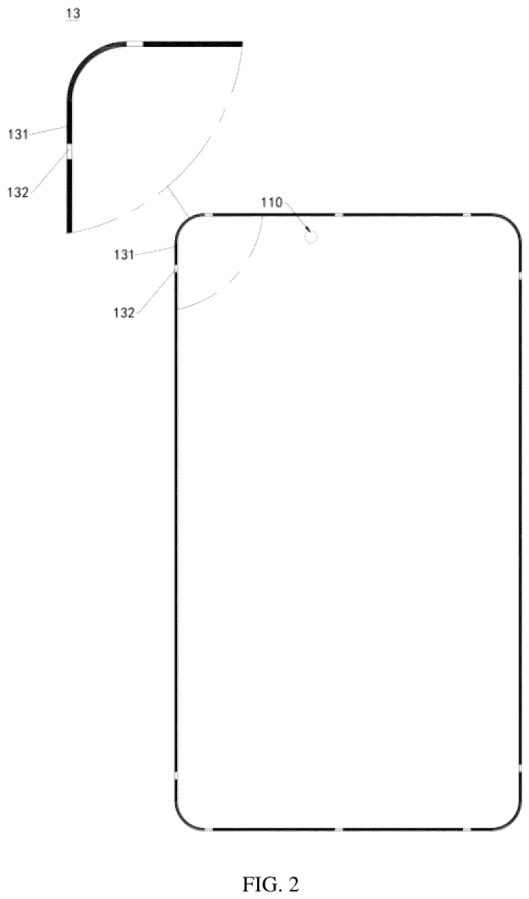

Refer to FIG. 1 and FIG. 2. FIG. 2 is a diagram of a structure of the frame 13 shown in FIG. 1 in some embodiments. FIG. 2 shows shapes and lengths of a plurality of first metal pieces 131 of the frame 13 in some embodiments, and cannot be understood as a limitation on the shapes and lengths of the plurality of first metal pieces 131 in embodiments of this application. In some other embodiments, the plurality of first metal pieces 131 may further have other shapes and lengths. This is not limited in embodiments of this application.

For example, the frame 13 may include a plurality of first metal pieces 131, the plurality of first metal pieces 131 extend along the frame 13, and there is a gap between two adjacent first metal pieces 131. Some or all of the plurality of first metal pieces 131 of the frame 13 may be used as the radiator of the antenna assembly 31, and the radiator is configured to radiate or receive an electrical signal. For example, a radiator of a single antenna assembly 31 may include one or more first metal pieces 131. This is not limited in embodiments of this application. In embodiments of this application, a gap between two adjacent radiators increases a capacitance and implements impedance matching.

A dielectric component 132 may be disposed in the gap between the two adjacent first metal pieces 131, and the dielectric component 132 is fastened to the two adjacent first metal pieces 131. The dielectric component 132 may be prepared in a manner of filling a dielectric material in the gap, or the like. For example, the dielectric component 132 may be made of a dielectric material like plastic, and a dielectric constant of the dielectric component 132 can affect impedance performance of the antenna. For example, the dielectric component 132 and the metal piece may differ in appearance (a shape, a size, a color, and the like), and the dielectric component 132 and the metal piece may also have a same appearance. This is not limited in this application.

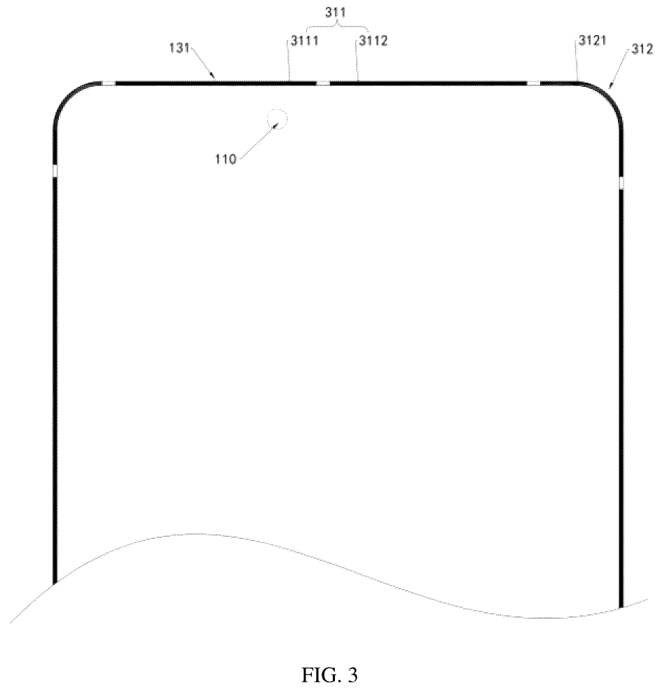

Refer to FIG. 2 and FIG. 3. FIG. 3 is a diagram of a partial structure of the frame 13 shown in FIG. 2 in some embodiments.

For example, the antenna assembly 31 of the antenna module 3 may include a first antenna 311 (namely, an antenna 311) and a second antenna 312, a radiator of the first antenna 311 includes a first branch 3111 and a second branch 3112, and a gap exists between the first branch 3111 and the second branch 3112. The radiator of the first antenna 311 may be implemented by using the first metal piece 131 of the frame 13, and the first branch 3111 and the second branch 3112 are two adjacent first metal pieces 131 of the frame 13. A radiator 3121 of the second antenna 312 may also be implemented by using the first metal piece 131 of the frame 13, and the radiator 3121 of the second antenna 312 may include one or more first metal pieces 131. The radiator 3121 of the second antenna 312 may also be implemented by using a part of the metal piece of the rear cover 12. In embodiments of this application, descriptions are provided by using an example in which the radiator 3121 of the second antenna 312 is implemented by using one first metal piece 131 of the frame 13.

In embodiments of this application, the electronic device 100 is the mobile phone. Based on a portability requirement, an appearance size of the mobile phone is small, that is, a length and a width of the mobile phone are small, and the length is greater than or equal to the width. A corresponding size of the screen 11 is 5.5 inches, 6.0 inches, 6.5 inches, or the like. Because both the length and the width (corresponding to a size of a long side and a size of a short side of the frame shown in FIG. 2) of the mobile phone are small, a distance between two antennas (for example, the first antenna 311 and the second antenna 312) disposed on the frame 13 is short. A maximum distance between the two antennas disposed on the frame 13 is shorter than or equal to the length of the mobile phone.

It may be understood that a short distance between the two antennas (for example, the first antenna 311 and the second antenna 312) results in poor isolation between the two antennas, which easily affects each other. This affects radiation performance of the two antennas, for example, reduces transmission efficiency, and damages a component like a filter. In embodiments of this application, in a multi-antenna application environment, when the distance between the first antenna 311 and the second antenna 312 is short, there may still be better isolation between the first antenna 311 and the second antenna 312 located on a peripheral side of the first antenna 311, so that the first antenna 311 and the second antenna 312 have better radiation performance, a service life of the component like the filter is long, and the electronic device 100 has better communication performance.

In some other embodiments, the antenna assembly 31 may also include only the first antenna 311, and the first branch 3111 and the second branch 3112 of the first antenna 311 are used as radiators to implement a radiation function.

In some embodiments, as shown in FIG. 3, the radiator (the first branch 3111 and the second branch 3112) of the first antenna 311 may be disposed at a top end of the frame 13, and the radiator 3121 of the second antenna 312 may also be disposed at the top end of the frame 13. The “top end” is described as follows: For example, a light transmission hole 110 is disposed on the screen 11, and light outside the housing apparatus 10 can enter the internal space of the housing apparatus 10 through the light transmission hole 110 (refer to FIG. 1, corresponding to positions of dashed circles in FIG. 2 and FIG. 3) and is received by a camera module or another optical detector. An end that is of the frame 13 and that is close to the light transmission hole 110 is the top end, an end that is of the frame 13 and that is away from the light transmission hole 110 is a bottom end, and parts that are of the frame 13 and that are located between the top end and the bottom end are side edges of the frame 13. For example, the optical detector may include one or more of a proximity detector and an infrared detector, and is configured to receive the light that enters the internal space of the housing apparatus 10 through the light transmission hole 110.

In some other embodiments, the radiator of the first antenna 311 may be disposed at the top end of the frame 13, and the radiator 3121 of the second antenna 312 may be disposed at the bottom end of the frame 13 or the side edge of the frame 13.

In some other embodiments, the radiator of the first antenna 311 may alternatively be disposed at the bottom end or the side edge of the frame 13, and the radiator 3121 of the second antenna 312 may alternatively be disposed at the top end of the frame 13. This is not limited in embodiments of this application.

For example, the radiator of the first antenna 311 and the radiator 3121 of the second antenna 312 may be disposed adjacently. The radiator of the first antenna 311 has, in an encircling direction of the frame 13, a first near end close to the second antenna 312 and a first far end opposite to the first near end, and the radiator 3121 of the second antenna 312 has, in the encircling direction of the frame 13, a second near end close to the first antenna 311 and a second far end opposite to the near end. There is no other metal structure between the first near end of the first antenna 311 and the second near end of the second antenna 312 in the encircling direction of the frame 13, and it may be considered that “the radiator of the first antenna 311 and the radiator 3121 of the second antenna 312 are disposed adjacently”.

In some other embodiments, there may alternatively be a metal structure like the first metal piece 131 between the first near end of the first antenna 311 and the second near end of the second antenna 312 in the encircling direction of the frame 13. This is not limited in this application.

In some other embodiments, the frame 13 may be a dielectric material. Metal structures such as a plurality of metal patches and/or a plurality of flexible circuit boards may be disposed at a side that is of the frame 13 and that faces the internal space of the housing apparatus 10. The metal structure may be used as a radiator of the first antenna 311 and/or a radiator of the second antenna 312.

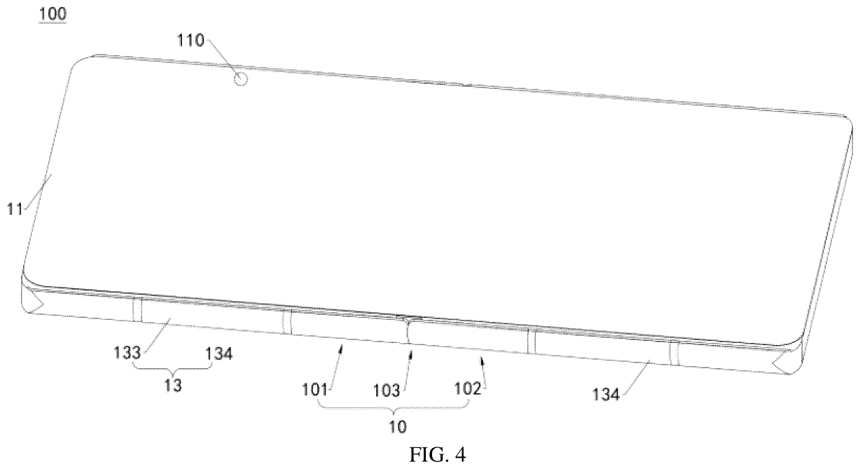

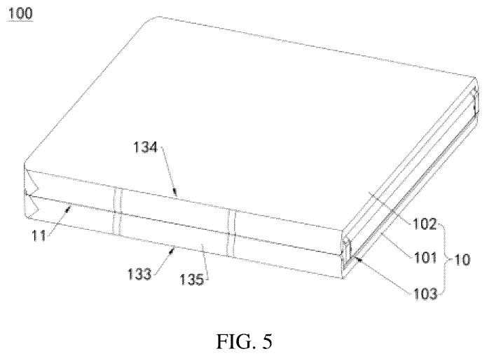

Refer to FIG. 4 and FIG. 5. FIG. 4 is a diagram of a structure of the electronic device 100 in some other embodiments according to this application. FIG. 5 is a diagram of the structure of the electronic device 100 shown in FIG. 4 in a folded state.

In some other embodiments, the mobile phone may alternatively be a foldable phone. For example, the electronic device 100 may include the housing apparatus 10 and the screen 11, and the screen 11 is mounted on the housing apparatus 10. As shown in FIG. 4, the housing apparatus 10 may be expanded to an unfolded state. As shown in FIG. 5, the housing apparatus 10 may also be folded to the folded state. The housing apparatus 10 may also be expanded or folded to an intermediate state, where the intermediate state may be any state between the unfolded state and the folded state. The screen 11 moves with the housing apparatus 10, and the housing apparatus 10 may drive the screen 11 to expand or fold, so that the electronic device 100 can be expanded to the unfolded state or folded to the folded state. When the electronic device 100 is in the folded state, the screen 11 is located on an inner side of the housing apparatus 10.

In embodiments of this application, when the electronic device 100 is in the unfolded state, the screen 11 is unfolded, and the screen 11 can be displayed in full screen, so that the electronic device 100 has a large display area, thereby improving viewing experience and operation experience of the user. When the electronic device 100 is in the folded state, a planar size of the electronic device 100 is small, so that it is convenient for the user to carry and store.

For example, the screen 11 includes a bendable flexible display. The flexible display may be a liquid crystal display (LCD), an organic light-emitting diode (OLED) display, an active-matrix organic light-emitting diode (AMOLED) display, a flexible light-emitting diode (FLED) display, a mini-LED display, a micro-LED display, a micro-OLED display, a quantum dots light-emitting diode (QLED) display, or the like.

In embodiments of this application, descriptions are provided by using an example in which the electronic device 100 is of a structure of two folds. To be specific, the electronic device 100 includes two plate parts and a bent part connected between the two plate parts. The two plate parts may rotate toward each other to be stacked (corresponding to the foregoing folded state), so that the electronic device 100 presents a two-layer form; or the two plate parts may also rotate away from each other to be unfolded (corresponding to the foregoing unfolded state). In some other embodiments, the electronic device 100 may alternatively be of a structure of more than three folds, or the like. To be specific, the electronic device 100 includes more than three plate parts, and two adjacent plate parts are connected through a bent part. The two adjacent plate parts may rotate toward each other to be stacked or rotate away from each other to be unfolded. When the electronic device 100 is of the structure of more than three folds, the structure of the electronic device 100 may be adaptively designed with reference to the descriptions of the structure of two folds in embodiments. Details are not described in this application.

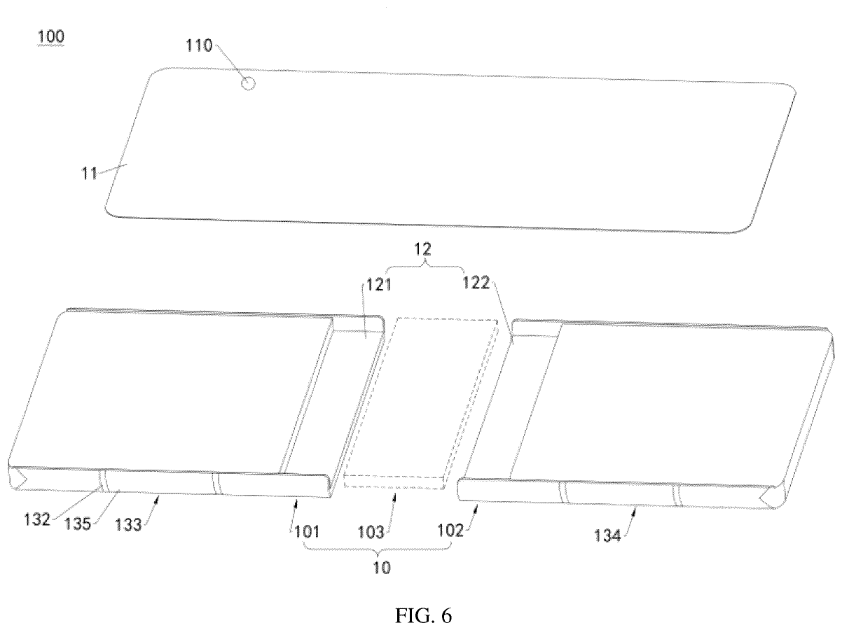

Refer to FIG. 6. FIG. 6 is a diagram of an exploded structure of the electronic device 100 shown in FIG. 4 in some embodiments. FIG. 6 shows only a structure of the electronic device 100 in some embodiments, and cannot be understood as a limitation on the structure of the electronic device 100. A dashed line structure in FIG. 6 merely shows a position of a hinge assembly 103, and cannot be understood as a limitation on a structure of the hinge assembly 103. For a specific structure of the hinge assembly 103, refer to a structure of the hinge assembly 103 in the conventional technology.

In some embodiments, the housing apparatus 10 includes a first housing 101, a second housing 102, and a hinge assembly 103. The hinge assembly 103 may be connected between the first housing 101 and the second housing 102. The hinge assembly 103 may deform, so that the first housing 101 and the second housing 102 can be expanded to the unfolded state or folded to the folded state. The screen 11 can move along with the first housing 101, the hinge assembly 103, and the second housing 102, to implement expanding and folding.

For example, the housing apparatus 10 may include the frame 13 and the rear cover 12, and the frame 13 encircles the rear cover 12. The frame 13 may include a first frame 133 and a second frame 134. The rear cover 12 may include a first rear cover 121 and a second rear cover 122. The first frame 133 and the first rear cover 121 are disposed in the first housing 101, and the first frame 133 encircles the first rear cover 121. The second frame 134 and the second rear cover 122 are disposed on the second housing 102, and the second frame 134 encircles the second rear cover 122. Both the first frame 133 and the second frame 134 are formed by three sequentially connected side edges, forming a “=”-shaped structure. When the electronic device 100 is in the unfolded state, an opening of the second frame 134 is disposed opposite to an opening of the first frame 133. When the electronic device 100 is in the folded state, the first frame 133 and the second frame 134 are in contact or have a small distance, and the three side edges of the first frame 133 and the second frame 134 are stacked.

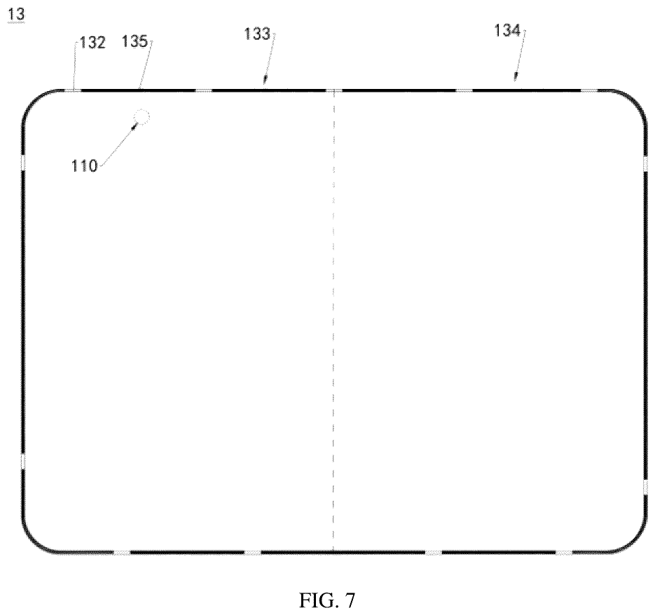

Refer to FIG. 7. FIG. 7 is a diagram of a structure of the frame 13 shown in FIG. 4 in some embodiments. Two sides of a dashed line in FIG. 7 are respectively the first frame 133 and the second frame 134. FIG. 7 shows shapes and lengths of a plurality of second metal pieces 135 of the frame 13 in some embodiments, and cannot be understood as a limitation on the shapes and lengths of the plurality of second metal pieces 135 in embodiments of this application. In some other embodiments, the plurality of second metal pieces 135 may further have other shapes and lengths. This is not limited in embodiments of this application.

For example, the first frame 133 may include a plurality of second metal pieces 135 and/or the second frame 134 may include a plurality of second metal pieces 135, the plurality of second metal pieces 135 extend along the frame 13, and a gap exists between two adjacent second metal pieces 135. Some or all of the plurality of second metal pieces 135 may be used as the radiator of the antenna assembly 31. For example, a radiator of a single antenna assembly 31 may include one or more second metal pieces 135. This is not limited in embodiments of this application.

A dielectric component 132 may be disposed in the gap between the two adjacent second metal pieces 135, and the dielectric component 132 is fastened to the two adjacent second metal pieces 135. The dielectric component 132 may be prepared in a manner of filling a dielectric material in the gap, or the like.

For example, as shown in FIG. 5, the second metal piece 135 of the first frame 133 and the second metal piece 135 of the second frame 134 are symmetrically disposed by using an axis of the hinge assembly 103 as a symmetry axis. In some other embodiments, the second metal piece 135 of the first frame 133 and the second metal piece 135 of the second frame 134 may alternatively be asymmetrically disposed.

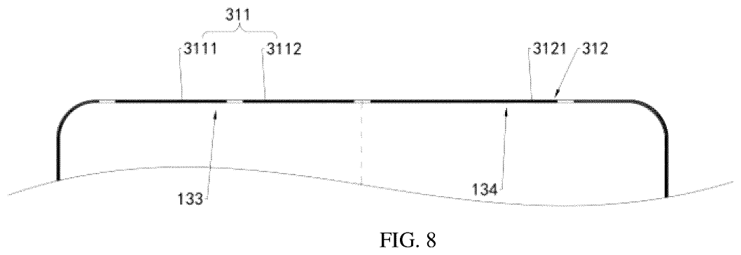

Refer to FIG. 7 and FIG. 8. FIG. 8 is a diagram of a partial structure of the frame 13 shown in FIG. 7 in some embodiments.

For example, the radiator of the first antenna 311 may be implemented by using the second metal piece 135 of the frame 13, and the first branch 3111 and the second branch 3112 are the two adjacent second metal pieces 135 of the frame 13. The radiator 3121 of the second antenna 312 may also be implemented by using the second metal piece 135 of the frame 13, and the radiator 3121 of the second antenna 312 may include one or more second metal pieces 135. The radiator 3121 of the second antenna 312 may also be implemented by using a part of the metal piece of the rear cover 12. In embodiments of this application, descriptions are provided by using an example in which the radiator 3121 of the second antenna 312 is implemented by using one second metal piece 135 of the frame 13.

In some embodiments, the radiator (the first branch 3111 and the second branch 3112) of the first antenna 311 and the radiator 3121 of the second antenna 312 may be respectively disposed on the first frame 133 and the second frame 134. For example, as shown in FIG. 8, the radiator of the first antenna 311 may be disposed on the first frame 133, and the radiator 3121 of the second antenna 312 may be disposed on the second frame 134.

In embodiments of this application, the electronic device 100 is a foldable mobile phone. The first antenna 311 and the second antenna 312 are respectively disposed in the first housing 101 and the second housing 102. When the electronic device 100 is in an unfolded state, because the mobile phone has a small size, a distance between the first antenna 311 and the second antenna 312 that are respectively disposed in the first housing 101 and the second housing 102 is short. When the electronic device 100 is in a folded state, because the first housing 101 and the second housing 102 are in a two-layer stacked state, a distance between the first antenna 311 and the second antenna 312 that are respectively disposed in the first housing 101 and the second housing 102 is also short.

In embodiments of this application, when the distance between the first antenna 311 and the second antenna 312 is short, there may still be better isolation between the first antenna 311 and the second antenna 312, so that the first antenna 311 and the second antenna 312 have better radiation performance, a service life of a component like a filter is long, and the electronic device 100 has better communication performance.

In some embodiments, the radiator (the first branch 3111 and the second branch 3112) of the first antenna 311 may be disposed at a top end of the first frame 133, and the radiator 3121 of the second antenna 312 may be disposed at a top end of the second frame 134, or the radiator 3121 of the second antenna 312 may be disposed at a bottom end or a side edge of the second frame 134.

The “top end”, “bottom end”, and “side edge” are described as follows: For example, a light transmission hole 110 is disposed on the screen 11 (refer to FIG. 4, corresponding to positions of dashed circles in FIG. 7 and FIG. 8), and light outside the housing apparatus 10 can enter the internal space of the housing apparatus 10 through the light transmission hole 110 and is received by a camera module or another optical detector. An end that is of the first frame 133 and that is close to the light transmission hole 110 is the top end, an end that is of the first frame 133 and that is away from the light transmission hole 110 is the bottom end, and parts that are of the first frame 133 and that are located between the top end and the bottom end are the side edges of the first frame 133. For example, the light transmission hole 110 may be located in a range enclosed by three side edges of the first frame 133, or the light transmission hole 110 may be located in a range enclosed by three side edges of the second frame 134. Alternatively, a part of the light transmission hole 110 may be located in a range enclosed by three side edges of the first frame 133, and the other part of the light transmission hole 110 may be located in a range enclosed by three side edges of the second frame 134.

For example, the radiator of the first antenna 311 may be disposed at the top end of the first frame 133, and the radiator 3121 of the second antenna 312 is disposed at the bottom end or the side edge of the second frame 134. This is not limited in embodiments of this application.

For example, the radiator of the first antenna 311 may alternatively be disposed at the bottom end or the side edge of the first frame 133, and the radiator 3121 of the second antenna 312 is disposed at the top end, the bottom end, or the side edge of the second frame 134. This is not limited in embodiments of this application.

In some other embodiments, the radiator of the first antenna 311 may alternatively be disposed on the second frame 134, and the radiator 3121 of the second antenna 312 may alternatively be disposed on the first frame 133.

In some other embodiments, both the radiator of the first antenna 311 and the radiator 3121 of the second antenna 312 may be disposed on the first frame 133 or the second frame 134. In embodiments of this application, descriptions are provided by using an example in which both the radiator of the first antenna 311 and the radiator 3121 of the second antenna 312 may be disposed on the first frame 133. For a specific implementation in which both the radiator of the first antenna 311 and the radiator 3121 of the second antenna 312 are disposed on the second frame 134, refer to an embodiment in which both the radiator of the first antenna 311 and the radiator 3121 of the second antenna 312 are disposed on the first frame 133.

In some embodiments, the radiator of the first antenna 311 may be disposed at the top end of the first frame 133, and the radiator 3121 of the second antenna 312 may alternatively be disposed at the top end of the first frame 133.

In some other embodiments, the radiator of the first antenna 311 may be disposed at the top end of the first frame 133, and the radiator 3121 of the second antenna 312 may be disposed at the bottom end of the first frame 133 or the side edge of the first frame 133.

In some other embodiments, the radiator of the first antenna 311 may alternatively be disposed at the bottom end or the side edge of the first frame 133, and the radiator 3121 of the second antenna 312 may alternatively be disposed at the top end of the first frame 133. This is not limited in embodiments of this application.

For example, the radiator of the first antenna 311 and the radiator 3121 of the second antenna 312 may be disposed adjacently. The radiator of the first antenna 311 has, in an encircling direction of the first frame 133, a first near end close to the second antenna 312 and a first far end opposite to the first near end, and the radiator 3121 of the second antenna 312 has, in the encircling direction of the first frame 133, a second near end close to the first antenna 311 and a second far end opposite to the near end. There is no other metal structure between the first near end of the first antenna 311 and the second near end of the second antenna 312 in the encircling direction of the first frame 133, and it may be considered that “the radiator of the first antenna 311 and the radiator 3121 of the second antenna 312 are disposed adjacently”.

In some other embodiments, there may alternatively be a metal structure like a metal piece between the first near end of the first antenna 311 and the second near end of the second antenna 312 in the encircling direction of the first frame 133. This is not limited in this application.

In some other embodiments, the radiator of the first antenna 311 may be disposed at the bottom end or the side edge of the first frame 133, and the radiator 3121 of the second antenna 312 may be disposed at the top end of the second frame 134, or the radiator 3121 of the second antenna 312 may be disposed at the bottom end or the side edge of the second frame 134.

In some other embodiments, the frame 13 may be a dielectric material. Metal structures such as a plurality of metal patches and/or a plurality of flexible circuit boards may be disposed at a side that is of the frame 13 and that faces the internal space of the housing apparatus 10. The metal structure may be used as a radiator of the first antenna 311 and/or a radiator of the second antenna 312.

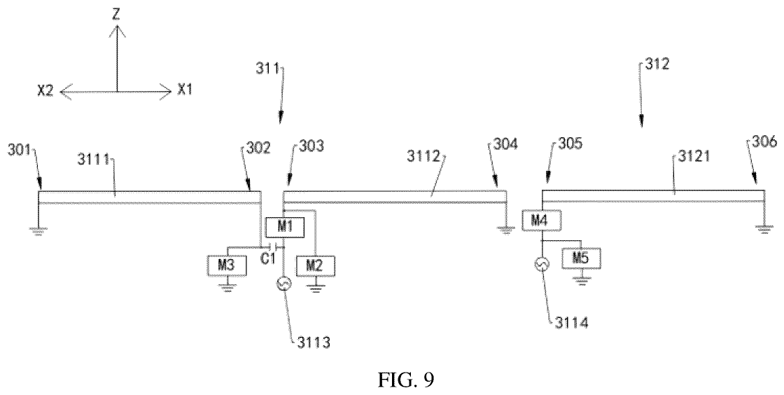

Refer to FIG. 9. FIG. 9 is a diagram of a structure of the first antenna 311 and the second antenna 312 shown in FIG. 3 and FIG. 8 in some embodiments.

For example, the first branch 3111 of the first antenna 311, the second branch 3112 of the first antenna 311, and the radiator 3121 of the second antenna 312 are sequentially disposed on a same straight line. The second branch 3112 of the first antenna 311 is located between the first branch 3111 of the first antenna 311 and the radiator 3121 of the second antenna 312. In some other embodiments, the radiator of the first antenna 311 and the radiator 3121 of the second antenna 312 may alternatively be arranged in another manner. This is not limited in embodiments of this application.

For example, the first antenna 311 may further have a first matching circuit, and the first matching circuit may include one or more matching modules. The first matching circuit may be configured to implement impedance matching for the first antenna 311, to improve radiation performance of the first antenna 311. For example, as shown in FIG. 9, the first matching circuit may include a first matching module M1, a first capacitor C1, and a first feeding portion 3113 (namely, the feeding portion 3113). A first end of the first matching module M1 is connected to the second branch 3112, a second end of the first matching module M1 is connected to the first feeding portion 3113, a first end of the first capacitor C1 is connected to the first branch 3111, and a second end of the first capacitor C1 is connected between the first matching module M1 and the first feeding portion 3113. In embodiments of this application, a component like a matching module, a capacitor, or an inductor is configured to perform signal transmission, and a signal is transmitted between a first end and a second end of the component. For example, the signal may flow in from the first end of the component, and flow out from the second end of the component after being processed by the component; or the signal may flow in from the second end of the component, and flow out from the first end of the component after being processed by the component.

For example, the first matching module M1 may include a second capacitor and/or an inductor. As shown in FIG. 9, in embodiments of this application, the first matching module M1 may use the second capacitor. In some other embodiments, the first matching module M1 may alternatively use the inductor or a circuit including the capacitor and the inductor, and is configured to adjust impedance matching.

For example, the first antenna 311 may further include a second matching module M2, and the second matching module M2 is connected to the second end of the first matching module M1. The second matching module M2 may be configured to perform impedance matching, to improve radiation performance of the second branch 3112. For example, the second matching module M2 may be a capacitor.

For example, the first antenna 311 may further include a third matching module M3. The third matching module M3 is connected to the first end of the first capacitor C1. The third matching module M3 may be configured to perform impedance matching, to improve radiation performance of the first branch 3111. For example, the third matching module M3 may be a capacitor.

For example, the second antenna 312 may further include a second feeding portion 3114. The radiator 3121 of the second antenna 312 has a first end 305 close to the second branch 3112 and a second end 306 away from the second branch 3112. The second feeding portion 3114 may be connected to the first end 305 of the radiator 3121 of the second antenna 312, and the second end 306 of the radiator 3121 of the second antenna 312 may be grounded. The second feeding portion 3114 feeds the radiator 3121 of the second antenna 312, and the radiator 3121 of the second antenna 312 radiates an electrical signal fed by the second feeding portion 3114, to implement a radiation function of the second antenna 312.

In some other embodiments, the second feeding portion 3114 may alternatively be connected to the second end 306 of the radiator 3121 of the second antenna 312, and the first end 305 of the radiator 3121 of the second antenna 312 may be grounded.

For example, the second antenna 312 may further have a second matching circuit, and the second matching circuit may include one or more matching modules. The second matching circuit may be configured to implement impedance matching for the second antenna 312, to improve radiation performance of the second antenna 312. For example, the second matching circuit of the second antenna 312 may include a fourth matching module M4 and a fifth matching module M5, and the fourth matching module M4 and the fifth matching module M5 are collectively referred to as matching modules of the second matching circuit. A first end of the fourth matching module M4 is connected to the radiator 3121 of the second antenna 312, a second end of the fourth matching module M4 is connected to the second feeding portion 3114, and a fifth matching module M5 is connected between the fourth matching module M4 and the second feeding portion 3114.

Both the fourth matching module M4 and the fifth matching module M5 may include one or more matching components, and the matching components may be capacitors or inductors. For example, the fourth matching module M4 may be the capacitor, and the fifth matching module M5 may be the capacitor or the inductor. The fourth matching module M4 may be configured to perform impedance matching, to improve radiation performance of the second antenna 312. When a dimension of the radiator 3121 of the second antenna 312 remains unchanged, a resonant frequency of the second antenna 312 can be adjusted by selecting a type of the matching component of the fifth matching module M5 and adjusting a value of the matching component. The type of the matching component of the fifth matching module M5 may be the capacitor or the inductor, and the value of the matching component is a value of a capacitance of the capacitor or a value of the inductor.

In embodiments of this application, antenna performance of the second antenna 312 can be adjusted by adjusting at least one of the fourth matching module M4 or the fifth matching module M5. For example, a value of a capacitance of the capacitor of the fourth matching module M4 may be adjusted, or the type of the matching component of the fifth matching module M5 may be selected and the value of the matching component may be adjusted.

In some other embodiments, the second antenna 312 may include only the fourth matching module M4 or the fifth matching module M5. Specifically, the second antenna 312 may include only the fourth matching module M4, and does not include the fifth matching module M5. The second feeding portion 3114 feeds the radiator 3121 of the second antenna 312 by using the fourth matching module M4. Alternatively, the second antenna 312 may include only the fifth matching module M5, and does not include the fourth matching module M4. The second feeding portion 3114 is connected to the first end 305 of the radiator 3121 of the second antenna 312, and feeds the radiator 3121 of the second antenna 312. The fifth matching module M5 is connected to the first end 305 of the radiator 3121 of the second antenna 312.

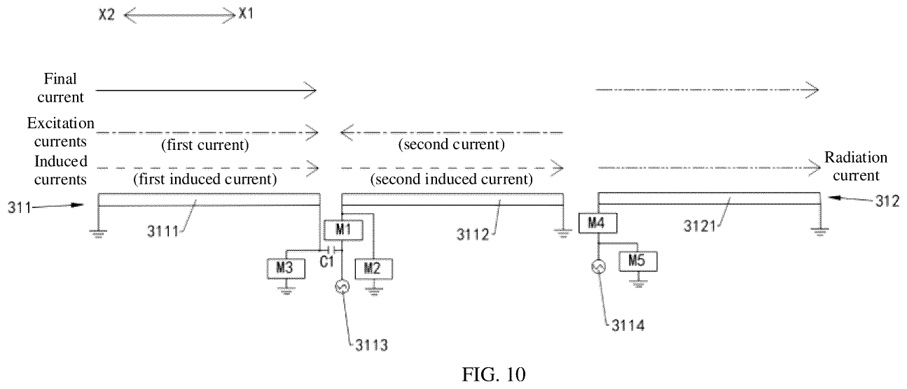

For the matching modules, refer to FIG. 9 and FIG. 10. FIG. 10 is a diagram of current distribution of the first antenna 311 and the second antenna 312 shown in FIG. 9. FIG. 10 shows directions of currents in some embodiments. In some other embodiments, the currents may also have other directions. FIG. 10 cannot be understood as a limitation on the directions of the currents.

The second feeding portion 3114 feeds the radiator 3121 of the second antenna 312, to excite a radiation current on the radiator 3121 of the second antenna 312. The energized second antenna 312 can excite induced currents on the first branch 3111 and the second branch 3112. It should be noted that, when the first branch 3111 and the second branch 3112 are not energized, currents excited by the energized second antenna 312 on the first branch 3111 and the second branch 3112 are the induced currents. That the first feeding portion 3113 does not input an electrical signal to the first branch 3111 and the second branch 3112 is that the first branch 3111 and the second branch 3112 are not energized, and that the second feeding portion 3114 inputs an electrical signal to the radiator 3121 of the second antenna 312 is that the second antenna 312 is energized. The induced current on the first antenna 311 causes electromagnetic interference to the current on the second antenna 312. This reduces transmission efficiency of the second antenna 312. For example, as shown in FIG. 10, a direction of a first induced current on the first branch 3111 is the same as a direction of a second induced current on the second branch 3112, and both are a first direction X1 shown in FIG. 10.

For example, the energized second antenna 312 generates the first induced current on the first branch 3111, and generates the second induced current on the second branch 3112, where the first induced current is smaller than the second induced current. In this embodiment, the first induced current generated by the energized second antenna 312 on the first branch 3111 is smaller than the second induced current generated by the energized second antenna 312 on the second branch 3112, that is, isolation between the second antenna 312 and the second branch 3112 is poorer than isolation between the second antenna 312 and the first branch 3111. A larger induced current generated by the energized second antenna 312 on the radiator (the first branch 3111 or the second branch 3112) on a periphery of the energized second antenna 312 indicates poorer isolation between the energized second antenna 312 and the radiator (the first branch 3111 or the second branch 3112). That is, if the first induced current generated by the energized second antenna 312 on the first branch 3111 is smaller than the second induced current generated by the energized second antenna 312 on the second branch 3112, isolation between the second antenna 312 and the second branch 3112 is poorer than isolation between the second antenna 312 and the first branch 3111. In embodiments of this application, a magnitude of the second induced current on the second branch 3112 needs to be reduced, to reduce interference of the second induced current on the second branch 3112 to the second antenna 312, and improve isolation between the first antenna 311 and the second antenna 312.

Refer to FIG. 2, FIG. 7, and FIG. 10. In some embodiments, the first branch 3111, the second branch 3112, and the radiator 3121 of the second antenna 312 are disposed along the encircling direction of the frame 13. The second branch 3112 is located between the first branch 3111 and the radiator 3121 of the second antenna 312, that is, the distance between the second branch 3112 and the second antenna 312 is shorter than the distance between the first branch 3111 and the second antenna 312. In this case, the first induced current generated by the energized second antenna 312 on the first branch 3111 is smaller than the second induced current generated by the energized second antenna 312 on the second branch 3112.

In some other embodiments, the distance between the first branch 3111 and the radiator 3121 of the second antenna 312 is equal to the distance between the second branch 3112 and the radiator 3121 of the second antenna 312. For example, the first branch 3111 and the second branch 3112 are disposed at the top end of the frame 13, and the radiator 3121 of the second antenna 312 is disposed at the bottom end of the frame 13. Alternatively, the first branch 3111 and the second branch 3112 are disposed at the bottom end of the frame 13, and the radiator 3121 of the second antenna 312 is disposed at the top end of the frame 13. In embodiments of this application, because of a matching environment between the first antenna 311 and the second antenna 312, the first induced current generated by the energized second antenna 312 on the first branch 3111 is smaller than the second induced current generated by the energized second antenna 312 on the second branch 3112. In embodiments of this application, a distance between a midpoint of the first branch 3111 in an extension direction of the first branch and a midpoint of the radiator 3121 of the second antenna 312 in an extension direction of the radiator is the distance between the first branch 3111 and the radiator 3121 of the second antenna 312, and a distance between a midpoint of the second branch 3112 in an extension direction of the second branch and the midpoint of the radiator 3121 of the second antenna 312 in the extension direction of the radiator is the distance between the second branch 3112 and the radiator 3121 of the second antenna 312.

The first branch 3111 has a first end portion 301 and a second end portion 302 that are oppositely disposed, the second branch 3112 has a third end portion 303 and a fourth end portion 304 that are oppositely disposed, and the second end portion 302 and the third end portion 303 are located between the first end portion 301 and the fourth end portion 304. In embodiments of this application, the first feeding portion 3113 feeds the second end portion 302 of the first branch 3111 by using the first capacitor C1, and feeds the third end portion 303 of the second branch 3112 by using the first matching module M1. In the foregoing feeding manner, the first feeding portion 3113 can excite slot differential-mode currents on the first branch 3111 and the second branch 3112. To be specific, as shown in FIG. 10, the first feeding portion 3113 excites a first current on the first branch 3111, and the first feeding portion 3113 excites a second current on the second branch 3112. The first current and the second current have opposite current directions and a same magnitude. A direction of the first current is the first direction X1 shown in FIG. 10, and a direction of the second current is a second direction X2 shown in FIG. 10. The first direction X1 is opposite to the second direction X2. In some other embodiments, the direction of the first current may alternatively be the same as the direction of the second current, provided that the direction of the second current is opposite to the direction of the second induced current. In addition, the first current may alternatively have a direction different from the first direction X1, and the second current may alternatively have a direction different from the second direction X2. This is not limited in embodiments of this application.

In addition, in embodiments of this application, the first capacitor C1 feeds the second end portion 302 of the first branch 3111, and the first matching module M1 feeds the third end portion 303 of the second branch 3112. The slot differential-mode currents are excited on the first branch 3111 and the second branch 3112, so that the direction of the second current on the second branch 3112 is opposite to the direction of the second induced current on the second branch 3112. Because the direction of the second current on the second branch 3112 is opposite to the direction of the second induced current on the second branch 3112, the second current may cancel the second induced current. This reduces a current on the second branch 3112, that is, almost no current exists on the second branch 3112. In some other embodiments, because a current magnitude of the second current may be smaller than a current magnitude of the second induced current, a part of the second induced current may also exist on the second branch 3112. In addition, the direction of the first current on the first branch 3111 is the same as the direction of the first induced current, and the first current and the first induced current are superposed, so that a final current on the first branch 3111 is along the first direction, and a magnitude of the final current is approximately equal to a sum of the first induced current and the first current. Because almost no current exists on the second branch 3112, the radiation current on the radiator 3121 of the second antenna 312 is not interfered or is less interfered. This optimizes isolation between the first antenna 311 and the second antenna 312. In addition, the first branch 3111 has the large final current, and can perform radiation. This can ensure antenna performance of the first antenna 311 while optimizing isolation between the first antenna 311 and the second antenna 312.

In conclusion, in embodiments of this application, in a multi-antenna application environment, the second antenna 312 located on the periphery of the first antenna 311 excites the induced currents on the radiator of the first antenna 311, and the induced currents on the radiator of the first antenna 311 cause electromagnetic interference to the current on the radiator 3121 of the second antenna 312. Consequently, isolation between the first antenna 311 and the second antenna 312 is poor.

The first feeding portion 3113 feeds the first branch 3111 and the second branch 3112, to excite, on the second branch 3112, the second current (excitation current) with the direction opposite to the direction of the second induced current, and the second current can cancel the second induced current excited by the second antenna 312 on the second branch 3112, reduce electromagnetic interference caused by the first antenna 311 to the second antenna 312, and ensure transmission efficiency of the second antenna 312.

In addition, the first capacitor C1 is disposed between the first branch 3111 and the second branch 3112. The first capacitor C1 can adjust impedance matching for the first antenna 311, so as to adjust a magnitude of the second current. The second current can be used to cancel, as much as possible, the second induced current excited by the second antenna 312 on the second branch 3112, so that almost no current exists on the second branch 3112. This further reduces interference caused by the second induced current on the second branch 3112 to the second antenna 312, improves isolation between the first antenna 311 and the second antenna 312, and improves transmission efficiency of the second antenna 312.

In addition, the first capacitor C1 is connected between a series matching position of the first branch 3111 and a series matching position of the second branch 3112, and the series matching position of the second branch 3112 is an end that is of the first matching module M1 and that is away from the second branch 3112. One end of the first capacitor C1 is connected to one end that is of the first matching module M1 and that is far away from the second branch 3112, is connected to the first feeding portion 3113, instead of being connected between the first matching module M1 and the second branch 3112, and is connected to the first feeding portion 3113 after passing through the first matching module M1. This simplifies a feeding circuit and reduces design difficulty of the feeding circuit. The feeding circuit is a circuit connected between the feeding portion and the radiator.

In addition, the first matching module M1 is connected between the first feeding portion 3113 and the second branch 3112, and is configured to implement impedance matching for the first antenna 311, so as to reduce a length of the second branch 3112 while ensuring radiation performance of the second branch 3112.

For example, as shown in FIG. 9, the first end portion 301 may be grounded, and the first capacitor C1 may be connected to the second end portion 302. The first matching module M1 may be connected to the third end portion 303, and the fourth end portion 304 is grounded.

In embodiments of this application, both the first branch 3111 and the second branch 3112 may form a left-hand antenna, where a dimension of the left-hand antenna is small. This facilitates miniaturization of the antenna. In some other embodiments, the first branch 3111 may alternatively form another antenna and/or the second branch 3112 may alternatively form another antenna, for example, an IFA (inverted-F antenna) antenna. The IFA antenna has a simple structure and a small dimension, and impedance matching is easily adjusted.

For example, the first branch 3111 and the second branch 3112 may form antennas of a same type, or may form antennas of different types.

For example, a capacitance of the first capacitor C1 may be less than or equal to 1.5 picofarads. In embodiments of this application, a value of the first capacitor C1 can be adjusted to optimize isolation between the first antenna 311 and the second antenna 312, and ensure antenna performance of the first antenna 311 and the second antenna 312. The capacitance of the first capacitor C1 is set within this range, so that a magnitude of the excitation current (the second current) on the second branch 3112 is close to a magnitude of the second induced current on the second branch 3112, thereby achieving technical effect of canceling, as much as possible, the second induced current excited by the second antenna 312 on the second branch 3112.

For example, the first branch 3111, the second branch 3112, and the radiator 3121 of the second antenna 312 all operate at least in a first frequency band. For example, the first branch 3111 operates in the first frequency band, the second branch 3112 operates in the first frequency band, and the radiator 3121 of the second antenna 312 operates in the first frequency band. When the second branch 3112 and the radiator 3121 of the second antenna 312 operate in a same frequency band, that is, the second branch 3112 operates in the first frequency band, and the radiator 3121 of the second antenna 312 operates in the first frequency band, isolation between the two radiators is poor. In embodiments of this application, a method for disposing the first branch 3111 and connecting the first capacitor C1 between the first branch 3111 and the second branch 3112 can effectively improve isolation between the second branch 3112 and the second antenna 312, and improve radiation performance of the second antenna 312.

For example, the first frequency band may be greater than or equal to 1.7 GHZ and less than or equal to 2.7 GHZ. For example, the first frequency band may be an MHB (middle high band) frequency band of an LTE system, and a frequency range covered by the MHB frequency band may be from 1.71 GHz to 2.69 GHz.

In some other embodiments, the second antenna 312 may also operate in a frequency band other than the first frequency band. For example, a frequency range covered by an operating frequency band of the second antenna 312 may be less than 1.71 GHz or greater than 2.69 GHz. This is not limited in embodiments of this application.

For example, a dimension of the first branch 3111 in an extension direction of the first branch is equal to ⅛ of an operating wavelength and/or a dimension of the second branch 3112 in an extension direction of the second branch is equal to ⅛ of an operating wavelength, and the operating wavelength is a wavelength corresponding to a center frequency of the first frequency band.

In embodiments of this application, feeding manners and grounding manners of the first branch 3111 and the second branch 3112 are designed, so that the first branch 3111 and the second branch 3112 form the left-hand antennas. A dimension of the radiator (the first branch 3111 and the second branch 3112) of the left-hand antenna may be ⅛ of the operating wavelength, and the dimension is small. This facilitates miniaturization of the antenna.

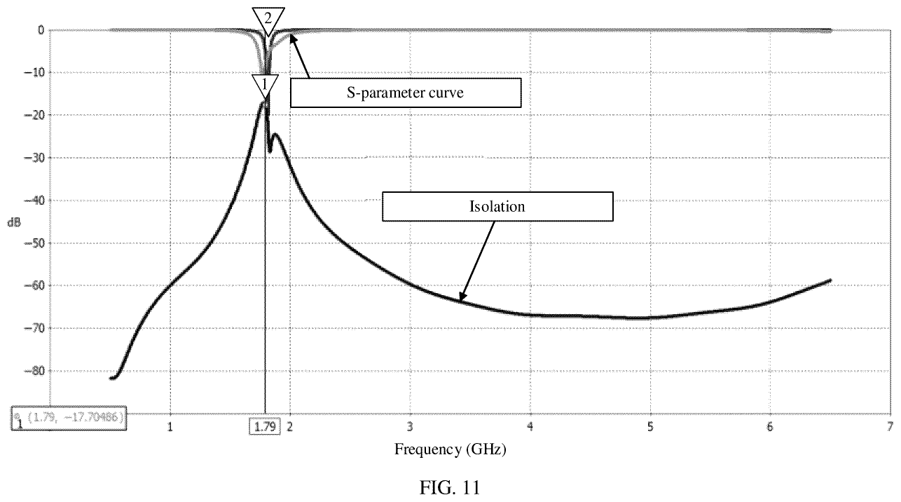

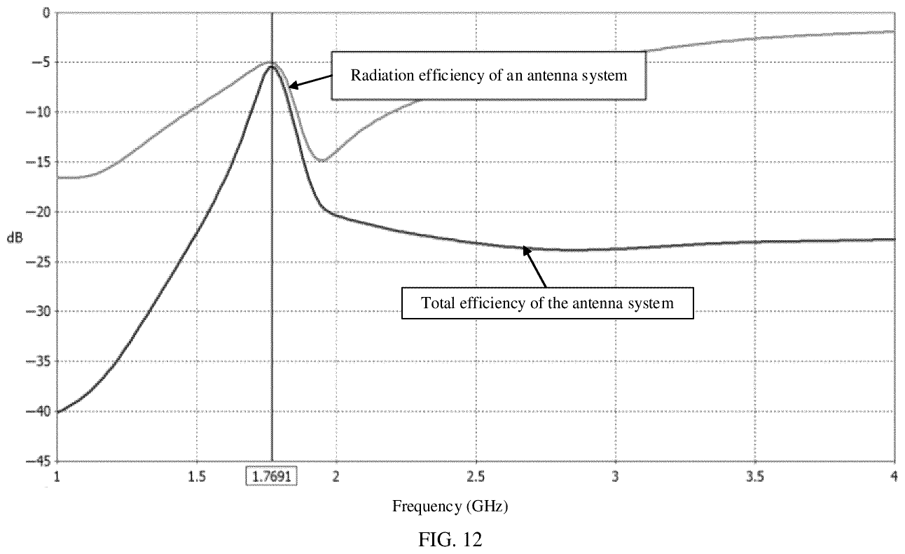

Refer to FIG. 9, FIG. 11, and FIG. 12. FIG. 11 is a diagram of an S-parameter curve and an isolation curve for a part of frequency bands, obtained by performing simulation on the first antenna 311 and the second antenna 312 shown in FIG. 9 in some embodiments. FIG. 12 is a diagram of efficiency curves for a part of frequency bands, obtained by performing simulation on the first antenna 311 and the second antenna 312 shown in FIG. 9 in some embodiments. A horizontal coordinate in FIG. 11 and FIG. 12 is a frequency in a unit of GHz, and a vertical coordinate is in a unit of dB.

In embodiments of this application, a simulation condition of an antenna system including the first antenna 311 and the second antenna 312 is as follows: A ground plane size of the antenna system is 162×72 mm², and a clearance of the antenna system is 1 mm. A dielectric constant (DK) of a dielectric material of the antenna system is 2.9, and a dissipation factor (DF) of the dielectric material is 0.01. A length of the first branch 3111 in the extension direction of the first branch is 11.8 mm, a length of the second branch 3112 in the extension direction of the second branch is 12.7 mm, and a length of the radiator 3121 of the second antenna 312 in an extension direction of the radiator is 8.7 mm. In addition, the first branch 3111, the second branch 3112, and the radiator 3121 of the second antenna 312 all have a thickness of 1.5 mm and a width of 3.8 mm. The first branch 3111, the second branch 3112, and the radiator 3121 of the second antenna 312 extend in a same direction. For example, the first branch 3111, the second branch 3112, and the radiator 3121 of the second antenna 312 all extend in the first direction X1. A thickness of a structure is a dimension of the structure in a third direction Z, and the third direction Z is parallel to a plane in which the screen 11 is located and perpendicular to the first direction X1. It should be noted that, when the electronic device 100 uses a structure of the foldable phone shown in FIG. 4, the third direction Z is parallel to the plane on which the screen 11 is located when the electronic device 100 is in the unfolded state. A width of the structure is a dimension of the structure in a fourth direction, and the fourth direction is perpendicular to the first direction X1 and the third direction Z (that is, the fourth direction is perpendicular to a plane of a paper, which is not shown in the figure).

As shown in FIG. 11, the first branch 3111, the second branch 3112, and the radiator 3121 of the second antenna 312, that is, the first antenna 311 and the second antenna 312, all resonate in a B3 frequency band. The B3 frequency band is a band3 frequency band of the LTE system, and a frequency range covered by the B3 frequency band may be from 1710 MHz to 1880 MHz.

It can be seen from FIG. 11 and FIG. 12 that isolation between the first antenna 311 and the second antenna 312 is 17.7 dB, and a highest efficiency point of the antenna system including the first antenna 311 and the second antenna 312 is-5.4 dB. Therefore, isolation between the first antenna 311 and the second antenna 312 is high, and the antenna system including the first antenna 311 and the second antenna 312 has high efficiency and good transmission performance.

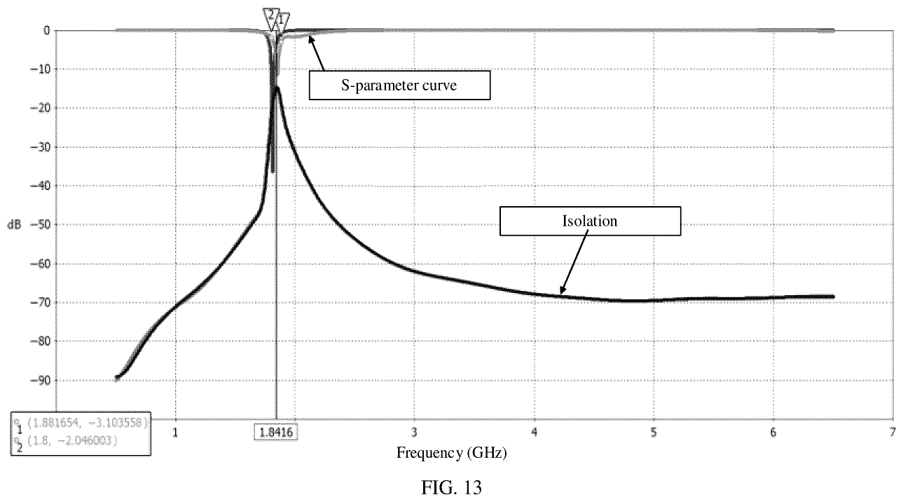

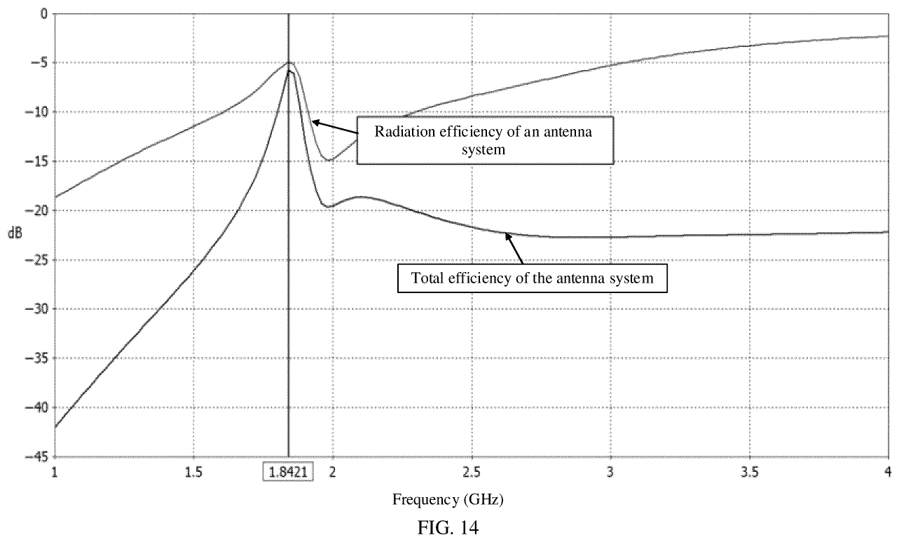

In addition, the capacitance of the first capacitor C1 may further affect operating frequency band ranges of the first branch 3111 and the second branch 3112. Refer to FIG. 11 to FIG. 14. FIG. 13 is a diagram of an S-parameter curve and an isolation curve for a part of frequency bands, obtained by performing simulation on the first antenna 311 and the second antenna 312 shown in FIG. 9 in some other embodiments. FIG. 14 is a diagram of efficiency curves for a part of frequency bands, obtained by performing simulation on the first antenna 311 and the second antenna 312 shown in FIG. 9 in some other embodiments. A horizontal coordinate in FIG. 13 and FIG. 14 is a frequency in a unit of GHz, and a vertical coordinate is in a unit of dB.

In some embodiments, the capacitance of the first capacitor C1 may alternatively be greater than or equal to 0.2 picofarads and less than or equal to 0.6 picofarads. A value of the first capacitor C1 can be adjusted to optimize isolation between the first antenna 311 and the second antenna 312, and ensure antenna performance of the first antenna 311 and the second antenna 312. For example, in the antenna system corresponding to FIG. 11 and FIG. 12, the capacitance of the first capacitor C1 may be 0.4 picofarads. A capacitance of a capacitor of the first matching module M1 may be greater than or equal to 0.8 picofarads and less than or equal to 1.5 picofarads. The first matching module M1 is configured to implement impedance matching for the first antenna 311. For example, the capacitance of the capacitor of the first matching module M1 may be 1 picofarad. A capacitance of a capacitor of the second matching module M2 may be 1.8 picofarads, and a capacitance of a capacitor of the third matching module M3 may be 2.8 picofarads. A resonant frequency of the second branch 3112 can be changed by adjusting the capacitance of the capacitor of the second matching module M2. A resonant frequency of the first branch 3111 can be changed by adjusting the capacitance of the capacitor of the third matching module M3. In embodiments, a frequency corresponding to the resonant frequency of the second branch 3112 is smaller than a frequency corresponding to the resonant frequency of the first branch 3111. In embodiments of this application, the capacitances of the capacitors of the second matching module M2 and the third matching module M3 are not limited, provided that the frequency corresponding to the resonant frequency of the second branch 3112 is smaller than the frequency corresponding to the resonant frequency of the first branch 3111.

In some other embodiments, the capacitance of the first capacitor C1 may alternatively be greater than or equal to 0.5 picofarads and less than or equal to 1.5 picofarads. A value of the first capacitor C1 can be adjusted to optimize isolation between the first antenna 311 and the second antenna 312, and ensure antenna performance of the first antenna 311 and the second antenna 312. For example, in the antenna system corresponding to FIG. 13 and FIG. 14, the capacitance of the first capacitor C1 may be 1.2 picofarads. A capacitance of a capacitor of the first matching module M1 may be greater than or equal to 0.3 picofarads and less than or equal to 0.7 picofarads. The first matching module M1 is configured to implement impedance matching for the first antenna 311. For example, the capacitance of the capacitor of the first matching module M1 may be 0.3 picofarads. A capacitance of a capacitor of the second matching module M2 may be 1.9 picofarads, and a capacitance of a capacitor of the third matching module M3 may be 2.05 picofarads. A resonant frequency of the second branch 3112 can be changed by adjusting the capacitance of the capacitor of the second matching module M2. A resonant frequency of the first branch 3111 can be changed by adjusting the capacitance of the capacitor of the third matching module M3. In embodiments, a frequency corresponding to the resonant frequency of the second branch 3112 is larger than a frequency corresponding to the resonant frequency of the first branch 3111. In embodiments of this application, the capacitances of the capacitors of the second matching module M2 and the third matching module M3 are not limited, provided that the frequency corresponding to the resonant frequency of the second branch 3112 is larger than the frequency corresponding to the resonant frequency of the first branch 3111.

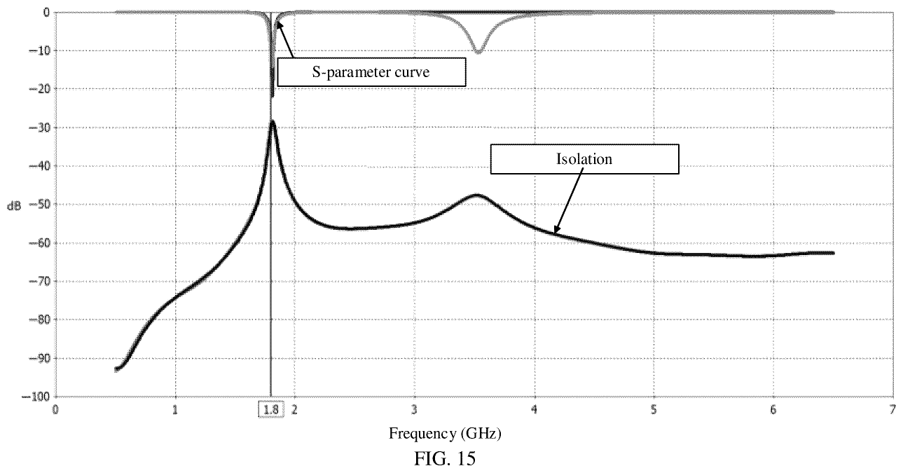

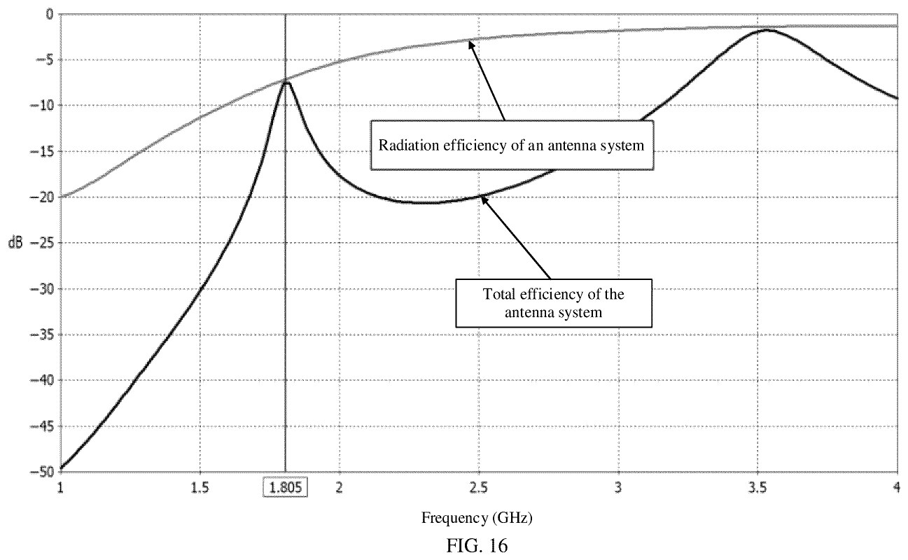

Refer to FIG. 15 and FIG. 16. FIG. 15 is a diagram of an S-parameter curve and an isolation curve for a part of frequency bands, obtained by performing simulation on the first antenna 311 and the second antenna 312 shown in FIG. 9 in some other embodiments. FIG. 16 is a diagram of efficiency curves for a part of frequency bands, obtained by performing simulation on the first antenna 311 and the second antenna 312 shown in FIG. 9 in some other embodiments. A horizontal coordinate in FIG. 15 and FIG. 16 is a frequency in a unit of GHz, and a vertical coordinate is in a unit of dB.

In some other embodiments, the second matching module M2 may use an inductor. In embodiments of this application, the second matching module M2 is disposed as the inductor, and the inductor and the second branch 3112 are connected in parallel, so that a second operating frequency band can be excited on the first antenna 311. This widens an operating frequency band range of the antenna, and facilitates miniaturization and integration of the antenna.

For example, the first branch 3111, the second branch 3112, and the radiator 3121 of the second antenna 312, that is, the first antenna 311 and the second antenna 312, all operate at least in the first frequency band, the first antenna 311 is also capable of operating in the second frequency band, and any frequency in the second frequency band is higher than any frequency in the first frequency band. In some embodiments, the second frequency band may be greater than or equal to 3.3 GHZ and less than or equal to 3.8 GHz.

For example, the capacitance of the first capacitor C1 may be greater than or equal to 0.4 picofarads and less than or equal to 1 picofarad. In embodiments, a value of the first capacitor C1 can be adjusted to optimize isolation between the first antenna 311 and the second antenna 312, and ensure antenna performance of the first antenna 311 and the second antenna 312. For example, in the antenna system corresponding to FIG. 15 and FIG. 16, the capacitance of the first capacitor C1 may be 0.5 picofarads.

A capacitance of a capacitor of the first matching module M1 may be greater than or equal to 0.3 picofarads and less than or equal to 0.7 picofarads. Impedance matching for the first antenna 311 may be implemented by adjusting the capacitance of the capacitor of the first matching module M1. For example, the capacitance of the capacitor of the first matching module M1 may be 0.3 picofarads. An inductance of the second matching module M2 may be 12 nanohenries (nH), and a capacitance of a capacitor of the third matching module M3 may be 2.9 picofarads. A resonant frequency of the second branch 3112 can be changed by adjusting the inductance of the second matching module M2. A resonant frequency of the first branch 3111 can be changed by adjusting the capacitance of the capacitor of the third matching module M3. Capacitances of capacitors of the second matching module M2 and the third matching module M3 are not limited in embodiments of this application.

As shown in FIG. 15, the first branch 3111, the second branch 3112, and the radiator 3121 of the second antenna 312, that is, the first antenna 311 and the second antenna 312, all resonate in a B3 frequency band. The first antenna 311 may further resonate in an N78 frequency band. A frequency range covered by the N78 frequency band may be from 3.3 GHz to 3.8 GHz.

It can be seen from FIG. 15 and FIG. 16 that isolation between the first antenna 311 and the second antenna 312 is 30 dB. When the antenna system including the first antenna 311 and the second antenna 312 operates in the B3 frequency band, a highest efficiency point of the antenna system is −7.5 dB; or when the antenna system including the first antenna 311 and the second antenna 312 operates in the N78 frequency band, a highest efficiency point of the antenna system is −2 dB.

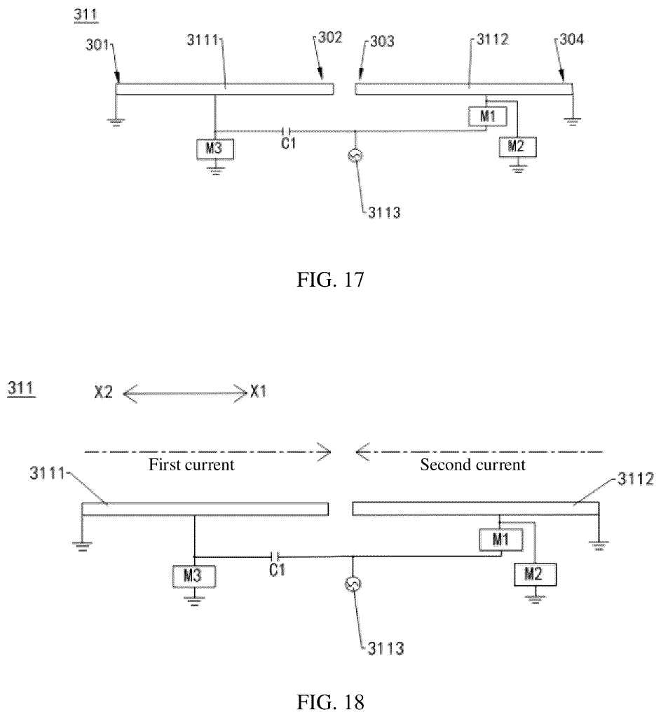

Refer to FIG. 17 and FIG. 18. FIG. 17 is a diagram of a structure of the first antenna 311 shown in FIG. 9 in some other embodiments. FIG. 18 is a diagram of current distribution of the first antenna 311 shown in FIG. 17.

In some embodiments, a connection point between the first capacitor C1 and the first branch 3111 may be located between the first end portion 301 and the second end portion 302, and the first end portion 301 or the second end portion 302 is grounded; and/or a connection point between the first matching module M1 and the second branch 3112 may be located between the third end portion 303 and the fourth end portion 304, and the third end portion 303 or the fourth end portion 304 is grounded.

In embodiments of this application, both the first branch 3111 and the second branch 3112 form an IFA antenna.

For example, a dimension of the first branch 3111 in an extension direction of the first branch is equal to ¼ of an operating wavelength and/or a dimension of the second branch 3112 in an extension direction of the second branch is equal to ¼ of an operating wavelength. A dimension of the radiator (the first branch 3111 and the second branch 3112) of the IFA antenna may be ¼ of the operating wavelength, and the dimension is small. This facilitates miniaturization of the antenna.

In embodiments of this application, the first feeding portion 3113 feeds the first branch 3111 by using the first capacitor C1, and feeds the second branch 3112 by using the first matching module M1. In the foregoing feeding manner, the first feeding portion 3113 can also excite slot differential-mode currents on the first branch 3111 and the second branch 3112. For example, the first feeding portion 3113 excites a first current on the first branch 3111, and the first feeding portion 3113 excites a second current on the second branch 3112. The first current and the second current have opposite current directions and a same magnitude.

For example, as shown in FIG. 18, a current direction of the first current is a first direction X1, and a current direction of the second current is a second direction X2. In some other embodiments, the current direction of the first current may alternatively be a second direction X2, and the current direction of the second current may alternatively be a first direction X1.

In embodiments of this application, currents in different modes can be excited on the first branch 3111 and the second branch 3112 by changing a feeding position of the first feeding portion 3113. The following provides descriptions by using specific embodiments.

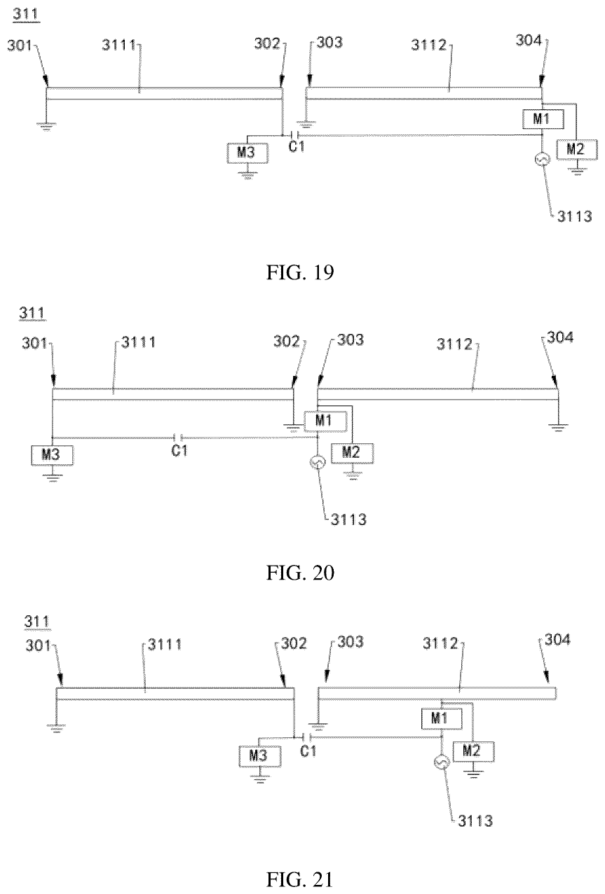

Refer to FIG. 19. FIG. 19 is a diagram of a structure of the first antenna 311 shown in FIG. 9 in some other embodiments.

In some embodiments, the first capacitor C1 may be connected to the first end portion 301, and the second end portion 302 may be grounded. The third end portion 303 may be grounded, and the first matching module M1 may be connected to the fourth end portion 304.

In embodiments of this application, the first feeding portion 3113 separately feeds the first end portion 301 of the first branch 3111 and the fourth end portion 304 of the second branch 3112, to excite a first current on the first branch 3111, and excite a second current on the second branch 3112. The first current and the second current have a same magnitude and opposite current directions.

Refer to FIG. 20. FIG. 20 is a diagram of a structure of the first antenna 311 shown in FIG. 9 in some other embodiments.

In some embodiments, the first capacitor C1 may be connected to the first end portion 301, and the second end portion 302 may be grounded. The first matching module M1 may be connected to the third end portion 303, and the fourth end portion 304 may be grounded.

In embodiments of this application, the first feeding portion 3113 separately feeds the first end portion 301 of the first branch 3111 and the fourth end portion 304 of the second branch 3112, to excite a first current on the first branch 3111, and excite a second current on the second branch 3112. The first current and the second current have a same magnitude and a same current direction.

Refer to FIG. 21. FIG. 21 is a diagram of a structure of the first antenna 311 shown in FIG. 9 in some other embodiments.

In some embodiments, the first end portion 301 may be grounded, and the first capacitor C1 may be connected to the second end portion 302. The third end portion 303 may be grounded, and the first matching module M1 may be connected to the fourth end portion 304.

In embodiments of this application, the first feeding portion 3113 separately feeds the first end portion 301 of the first branch 3111 and the fourth end portion 304 of the second branch 3112, to excite a first current on the first branch 3111, and excite a second current on the second branch 3112. The first current and the second current have a same magnitude and a same current direction.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Embodiments of this application and features in embodiments may be mutually combined, provided that no conflict occurs. Therefore, the protection scope of this application shall be subject to the protection scope of the claims.

What is claimed is:

1. An electronic device, comprising:
a frame;
a radiator of a first antenna disposed on the frame, the radiator of the first antenna comprising a first branch and a second branch, wherein a first gap is between the first branch and the second branch;
a radiator of a second antenna disposed on the frame, wherein the second branch is disposed between the first branch and the radiator of the second antenna, and a second gap exists between the second branch and the radiator of the second antenna;
a first matching module, wherein a first end of the first matching module is connected to the second branch
a first capacitor, wherein a first end of the first capacitor (C1) is connected to the first branch; and
a feeding portion, wherein a second end of the first matching module is connected to the feeding portion, and a second end of the first capacitor is connected between the first matching module and the feeding portion.

2. The electronic device according to claim 1, wherein the first branch has a first end portion and a second end portion that are disposed opposite to each other, and the second end portion is located between the first end portion and the second branch; and
wherein:
the first end portion is grounded, and the first capacitor is connected to the second end portion; or
a connection point between the first capacitor and the first branch is located between the first end portion and the second end portion, and the first end portion or the second end portion is grounded; or
the first capacitor is connected to the first end portion, and the second end portion is grounded.

3. The electronic device according to claim 2, wherein the second branch has a third end portion and a fourth end portion that are disposed opposite to each other, and the third end portion is located between the first branch and the fourth end portion; and
wherein:
the first matching module is connected to the third end portion, and the fourth end portion is grounded; or
a connection point between the first matching module and the second branch is located between the third end portion and the fourth end portion, and the third end portion or the fourth end portion is grounded; or
the third end portion is grounded, and the first matching module is connected to the fourth end portion.

4. The electronic device according to claim 1, wherein the first matching module comprises a second capacitor or an inductor.

5. The electronic device according to claim 1, wherein a capacitance of the first capacitor (C1) is less than or equal to 1.5 picofarads.

6. The electronic device according to claim 1, further comprising a second matching module, wherein a first end of the second matching module is connected to the second end of the first matching module, and a second end of the second matching module is grounded.

7. The electronic device according to claim 6, wherein the second matching module is a capacitor.

8. The electronic device according to claim 7, wherein:
the capacitance of the first capacitor is greater than or equal to 0.2 picofarads and less than or equal to 0.6 picofarads; or
the capacitance of the first capacitor is greater than or equal to 0.5 picofarads and less than or equal to 1.5 picofarads.

9. The electronic device according to claim 8, wherein both the first branch and the second branch operate at least in a first frequency band, and the first frequency band is greater than or equal to 1.7 GHZ and less than or equal to 2.7 GHZ.

10. The electronic device according to claim 6, wherein the second matching module is an inductor.

11. The electronic device according to claim 10, wherein the capacitance of the first capacitor is greater than or equal to 0.4 picofarads and less than or equal to 1 picofarad.

12. The electronic device according to claim 11, wherein the first branch, the second branch, and the second antenna all operate at least in a first frequency band, the second branch is further capable of operating in a second frequency band, and any frequency in the second frequency band is higher than any frequency in the first frequency band.

13. The electronic device according to claim 12, wherein the first frequency band is greater than or equal to 1.7 GHZ and less than or equal to 2.7 GHZ, and the second frequency band is greater than or equal to 3.3 GHZ and less than or equal to 3.8 GHz.

14. The electronic device according to claim 9, wherein the second antenna operates in the first frequency band.

15. The electronic device according to claim 12, wherein the second antenna operates in the first frequency band.

16. The electronic device according to claim 9, wherein a dimension of the first branch in an extension direction of the first branch is equal to ⅛ of an operating wavelength, or a dimension of the second branch in an extension direction of the second branch is equal to ⅛ of an operating wavelength; and
wherein the operating wavelength corresponds to a center frequency of the first frequency band.

17. The electronic device according to claim 12, wherein a dimension of the first branch in an extension direction of the first branch is equal to ⅛ of an operating wavelength, or a dimension of the second branch in an extension direction of the second branch is equal to ⅛ of an operating wavelength; and
wherein the operating wavelength corresponds to a center frequency of the first frequency band.

18. The electronic device according to claim 1, further comprises:
a third matching module, wherein a first end of the third matching module is connected to the first end of the first capacitor, and a second end of the third matching module is grounded.

19. The electronic device according to claim 1, wherein the first branch, the second branch, and the radiator of the second antenna are disposed along an encircling direction of the frame, and the second branch is located between the first branch and the radiator of the second antenna.

20. The electronic device according to claim 19, further comprising:
a hinge assembly;
a first housing and a second housing that are connected to two sides of the hinge assembly, wherein the first housing and the second housing are capable of being unfolded or folded relative to each other; and
wherein the frame comprises a first frame and a second frame, the first branch and the second branch are disposed on the first frame, the first frame is of the first housing, the radiator of the second antenna is disposed on the second frame, and the second frame is of the second housing.
